(19) United States
(12) Patent Application Publication
(10) Pub. No.: US 2025/0150983 A1
(43) Pub. Date: May 8, 2025

(54) OUT OF BAND BLOCKER HANDLING FOR LOCAL AREA BASE STATION

(71) Applicant: QUALCOMM Incorporated, San Diego, CA (US)

(72) Inventor: Mehboob Alam MUNSHI, Bengaluru (IN)

(21) Appl. No.: 18/501,392

(22) Filed: Nov. 3, 2023

(51) Int. Cl. H04W 52/24; H04W 48/02; H04W 52/36; H04W 52/52

(52) U.S. Cl. CPC H04W 52/243; H04W 48/02; H04W 52/367; H04W 52/52

(57) ABSTRACT

Methods, systems, and devices for out of band blocker handling for local area base stations are described. The described techniques may enable a network entity to partition a range of gain state values that may be used to adjust a radio receiver into a plurality of regions of operation. Each of the plurality of regions of operation may be associated with a respective blocker (e.g., narrow band, in-band, out-of-band, etc.). For example, the network entity may calculate a prescale backoff value to apply to a received signal for a particular gain state value within a corresponding region of operation. The calculated prescale backoff value may then be applied to received signal resulting in a prescaled signal which may then be processed and decoded by the network entity.

### FIELD OF TECHNOLOGY

The following relates to wireless communications at a network entity, including out of band blocker handling for local area base station.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Base stations in some wireless communications systems utilize various techniques to attenuate and filter sources of interference, however, the base stations are subject to sensitivity requirements in the presence of these various blockers and jammers.

### SUMMARY

The described techniques relate to improved methods, systems, devices, and apparatuses that support out of band blocker handling for local area base station. For example, the described techniques may enable a local network entity to partition a range of gain state values that may be used to adjust a radio receiver into a plurality of regions of operation. Each of the plurality of regions of operation may be associated with a respective blocker (e.g., narrow band, in-band, out-of-band, etc.). For example, the network entity may calculate a prescale backoff value to apply to a received signal for a particular gain state value within a corresponding region of operation. The calculated prescale backoff value may then be applied to received signal resulting in a prescaled signal which may then be processed and decoded by the network entity.

A method by a network entity is described. The method may include one or more memories storing processor-executable code, one or more processors coupling with the one or more memories and individually or collectively operable to execute the code to cause the network entity to, partition a range of gain state values into a set of multiple regions of operation, each of the set of multiple regions of operation being associated with a respective blocker of a set of multiple blockers, calculating, for a received signal, a prescale backoff value for one or more gain state values within the range of gain state values based on a particular gain state value being within a corresponding region of operation of the set of multiple regions of operation, applying the calculated prescale backoff value to the received signal, the application of the calculated prescale backoff value resulting in a prescaled signal, and processing the prescaled signal.

A network entity is described. The network entity may include one or more memories storing processor executable code, and one or more processors coupled with the one or more memories. The one or more processors may individually or collectively operable to execute the code to cause the network entity to one or more memories storing processor-executable code, one or more processors coupled with the one or more memories and individually or collectively operable to execute the code to cause the network entity to, partition a range of gain state values into a set of multiple regions of operation, each of the set of multiple regions of operation being associated with a respective blocker of a set of multiple blockers, calculate, for a received signal, a prescale backoff value for one or more gain state values within the range of gain state values based on a particular gain state value being within a corresponding region of operation of the set of multiple regions of operation, apply the calculated prescale backoff value to the received signal, the application of the calculated prescale backoff value resulting in a prescaled signal, and process the prescaled signal.

Another network entity is described. The network entity may include means for one or more memories storing processor-executable code, means for one or more processors coupling with the one or more memories and individually or collectively operable to execute the code to cause the network entity to, means for partition a range of gain state values into a set of multiple regions of operation, each of the set of multiple regions of operation being associated with a respective blocker of a set of multiple blockers, means for calculating, for a received signal, a prescale backoff value for one or more gain state values within the range of gain state values based on a particular gain state value being within a corresponding region of operation of the set of multiple regions of operation, means for applying the calculated prescale backoff value to the received signal, the application of the calculated prescale backoff value resulting in a prescaled signal, and means for processing the prescaled signal.

A non-transitory computer-readable medium storing code is described. The code may include instructions executable by a processor to one or more memories storing processor-executable code, one or more processors coupled with the one or more memories and individually or collectively operable to execute the code to cause the network entity to, partition a range of gain state values into a set of multiple regions of operation, each of the set of multiple regions of operation being associated with a respective blocker of a set of multiple blockers, calculate, for a received signal, a prescale backoff value for one or more gain state values within the range of gain state values based on a particular gain state value being within a corresponding region of operation of the set of multiple regions of operation, apply the calculated prescale backoff value to the received signal, the application of the calculated prescale backoff value resulting in a prescaled signal, and process the prescaled signal.

In some examples of the method, network entities, and non-transitory computer-readable medium described herein, to calculating the prescale backoff value may include operations, features, means, or instructions for determining that the particular gain state value may be either less than gain state values associated with a region of operation associated with a narrowband blocker, an in-band blocker, or an out-of-band blocker, or may be within a region of operation associated with the narrowband blocker and calculate, based on the determining, the prescale backoff value corresponding to the particular gain state value to be a maximum prescale backoff value.

In some examples of the method, network entities, and non-transitory computer-readable medium described herein, to calculating the prescale backoff value may include operations, features, means, or instructions for determining that the particular gain state value may be within a region of operation associated with an in-band blocker or an out-of-band blocker and calculate, based on the determining, the prescale backoff value corresponding to the particular gain state value based on a power value associated with a blocker of the set of multiple blockers, the particular gain state value, and a maximum prescale backoff value.

In some examples of the method, network entities, and non-transitory computer-readable medium described herein, the calculated prescale backoff value corresponding to the particular gain state value located at a border between a region of operation associated with a narrowband blocker and the region of operation associated with the in-band blocker may be a maximum prescale backoff value.

In some examples of the method, network entities, and non-transitory computer-readable medium described herein, the border between the region of operation associated with the narrowband blocker and the region of operation associated with the in-band blocker may be determined based on the power value associated with the blocker of the set of multiple blockers, a maximum gain for a receiver associated with the received signal, the maximum prescale backoff value, and a maximum signal for a fast Fourier transform core.

In some examples of the method, network entities, and non-transitory computer-readable medium described herein, the blocker may be a narrowband blocker.

In some examples of the method, network entities, and non-transitory computer-readable medium described herein, the prescale backoff value may be based on a maximum gain value for a modem associated with the network entity.

In some examples of the method, network entities, and non-transitory computer-readable medium described herein, to calculating the prescale backoff value may include operations, features, means, or instructions for determining that the particular gain state value may be greater than gain state values associated with regions of operation associated with a narrowband blocker, an in-band blocker, or an out-of-band blocker and calculate, based on the determining, the prescale backoff value corresponding to the particular gain state value to be a minimum prescale backoff value.

In some examples of the method, network entities, and non-transitory computer-readable medium described herein, the network entity may be a local network entity.

In some examples of the method, network entities, and non-transitory computer-readable medium described herein, partitioning the range of gain state values may include operations, features, means, or instructions for associating a maximum prescale backoff value to a first subrange of the range of gain state values, associate a variable prescale backoff value to a second subrange of the range of gain state values, and associate a minimum prescale backoff value to a third subrange of the range of gain state values, where the calculated prescale backoff value may be dependent on whether the particular gain state value may be within the first subrange, the second subrange, or the third subrange.

In some examples of the method, network entities, and non-transitory computer-readable medium described herein, to associating the variable prescale backoff value to the second subrange of the range of gain state values may include operations, features, means, or instructions for calculating a slope value corresponding to the variable prescale backoff value, where the slope value may be applied to the prescale backoff value between the first subrange of the range of gain state values and the third subrange of the range of gain state values.

Some examples of the method, network entities, and non-transitory computer-readable medium described herein may further include operations, features, means, or instructions for receiving, from an automatic gain control loop including one or more radio frequency components of the network entity, a control signal indicating the particular gain state value.

### BRIEF DESCRIPTION OF THE DRAWINGS

FIG. 1 shows an example of a wireless communications system that supports out of band blocker handling for local area base station in accordance with one or more aspects of the present disclosure.

FIG. 2 shows an example of a frequency diagram that supports out of band blocker handling for local area base station in accordance with one or more aspects of the present disclosure.

FIG. 3 shows an example of a radio frequency (RF) chain schematic that supports out of band blocker handling for local area base station in accordance with one or more aspects of the present disclosure.

FIG. 4 shows an example of a gain chart that supports out of band blocker handling for local area base station in accordance with one or more aspects of the present disclosure.

FIGS. 5 and 6 show block diagrams of devices that support out of band blocker handling for local area base station in accordance with one or more aspects of the present disclosure.

FIG. 7 shows a block diagram of a communications manager that supports out of band blocker handling for local area base station in accordance with one or more aspects of the present disclosure.

FIG. 8 shows a diagram of a system including a device that supports out of band blocker handling for local area base station in accordance with one or more aspects of the present disclosure.

FIG. 9 shows a flowchart illustrating methods that support out of band blocker handling for local area base station in accordance with one or more aspects of the present disclosure.

### DETAILED DESCRIPTION

Upon receiving a signal, a base station receiver will typically receive an intended signal and interfering signals (e.g., blockers and jammers). Some examples of blockers include narrow band blockers (NBB), in-band blockers (IBB), and out-of-band blockers (OBB). NBB refers to close-in jammers, some of which fall in a range of offsets from the wanted signal center frequency (−B/2, −Fₛ/2 to B/2, F/2, respectively, where B is the component carrier (CC) bandwidth and Fₛ is the base band sampling rate). IBB refers to jammers further away but within the same band (e.g., 3GPP defined). OBB refers to jammers outside the band of interest. In a typical network entity receiver, OBBs are attenuated by RF band pass filters (BPF) and analog base band filters (BBF). Typically, the BPF attenuates the OBB by 15 dB and the remaining part of the receiver chain sees a reduced OBB level of −30 dBm. IBBs gets attenuated by the analog BBF as well as the digital front end (DFE) filtering. NBBs may be attenuated by the DFE, but recent trends have avoided using sharp finite impulse response (FIR) filters for the last stage in the DFE to attenuate NBBs (due to supporting a large quantity of bandwidths, a corresponding large quantity of filters would be required). Instead, the selectivity of the Fast Fourier Transform (FFT) and the time domain filtering (window overlap and add (WOLA) filter) in the modem may be used to largely achieve the performance set forth in 3GPP.

However, conventional approaches to handle NBB with local network entities as opposed to medium or wide area network entities may be inadequate. Conventional techniques for network entities may apply a constant prescale backoff value where sensitivity with NBBs as well as the highest throughput at the highest modulation coding scheme (MCS) may be achieved. For local network entities, the NBB requirement is more stringent by 8 dB than the wide area network entity requirement and hence requires additional prescale backoff compared to a wide area network entities. Additionally, the local area network entity may be subject to sensitivity requirements with respect to IBB and OBB.

For example, at a 10 MHz CC bandwidth, the jammer to signal ratio (JSR) is 46 dB. 52 dB, and 57 dB at the low noise amplifier input for NBB, IBB, and OBB, respectively. Assuming an automatic gain control (AGC) setpoint of −15 dBFs, for NBB the target analog signal may be 46 dB below the jammer and an additional prescale backoff of 15 dB pushes the signal to −76 dBFs (−15−46−15=−76), with a resulting 15 dB FFT Signal-to-quantization-noise ratio (SQNR). Here, the overall signal-to-noise ratio (SNR) may not be dominated by FFT SQNR, and 3GPP sensitivity requirements may be met. However, for OBB, the wanted analog signal may be 57 dB below the jammer and the additional prescale backoff of 15 dB pushes the signal to −87 dBFs (−15−57−15=−87), which is close to the FFT quantization noise level (i.e., 0 dB SQNR). This scenario may result in FFT SQNR dominating the overall SNR and failures in sensitivity tests for OBB. Therefore, a constant prescale backoff for both NBB and OBB may result in failing sensitivity requirements. A way to discriminate between NBB and OBB while applying the additional prescale backoff is desired.

According to techniques described herein, for base station applications a wide range of gain states may be available in, for example, 1 dB steps, and the range of gain states may be partitioned into a plurality of regions of operation, where each of the plurality of regions of operation is associated with a respective blocker. Up to a region of operation, the additional prescale backoff may be set at a maximum level to meet NBB requirements. With a gain state value past the region of operation, the prescale backoff is calculated based on a plurality of inputs which allows the local base station receiver to meet IBB and OBB sensitivity requirements. After reaching a subsequent region of operation, the additional prescale backoff may be set at a minimum level. Stated differently, the range of gain states may be divided such that a first subrange is associated with a maximum prescale backoff value, a second subrange is associated with a variable prescale backoff, and a third subrange is associated with a minimum prescale backoff value. The applied prescale backoff may be dependent on the gain state received from a RF gain (e.g., gain state) received from the outer RF AGC components.

Aspects of the disclosure are initially described in the context of wireless communications systems. Aspects of the disclosure are further illustrated by and described with reference to schematic diagrams, frequency diagrams, and graphical representations of a gain chart. Aspects of the disclosure are further illustrated by and described with reference to apparatus diagrams, system diagrams, and flowcharts that relate to out of band blocker handling for local area base station.

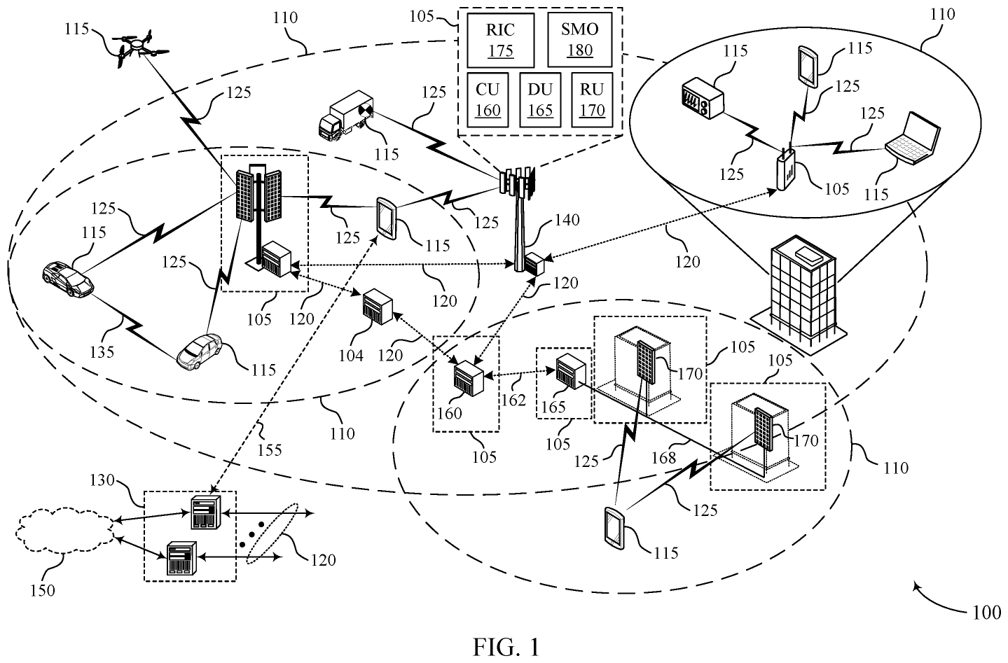

FIG. 1 shows an example of a wireless communications system 100 that supports out of band blocker handling for local area base station in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support out of band blocker handling for local area base station as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The described techniques may enable a network entity 105 to partition a range of gain state values that may be used to adjust a radio receiver into a plurality of regions of operation. Each of the plurality of regions of operation may be associated with a respective blocker (e.g., narrow band, in-band, out-of-band, etc.). For example, the network entity 105 may calculate a prescale backoff value to apply to a received signal for a particular gain state value within a corresponding region of operation. The calculated prescale backoff value may then be applied to received signal resulting in a prescaled signal which may then be processed and decoded by the network entity.

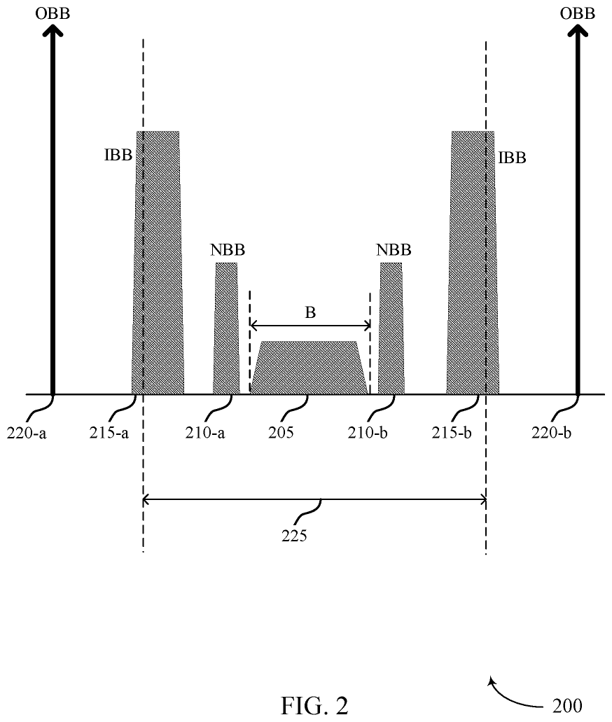

FIG. 2 shows an example of a frequency diagram 200 that supports out of band blocker handling for local area base station in accordance with one or more aspects of the present disclosure. Frequency diagram 200 may illustrate an example of a frequency domain diagram of a various spectral components of a signal received by a network entity 105.

Frequency diagram 200 comprises a signal 205 and various blockers including narrowband blockers (NBB) 210, in-band blockers (IBB) 215, and out-of-band blockers (OBB) 220. Signal 205 is located at a component carrier bandwidth B and may be the intended signal for a network entity 105 to receive from another wireless entity, such as a UE 115, another network entity 105, etc.

NBB 210 may fall in a range of offsets from the wanted signal center frequency (−B/2, −Fₛ/2 to B/2, Fₛ/2, respectively, where Fₛ is the base band sampling rate). IBB 215 may be further away in frequency from signal 205 than NBB 210, but may still be within the same band. Frequency range 225 may define a band of interest where a frequency band may include a signal 205 but may also include various blockers (e.g., NBB 210 and IBB 215). OBB 220 may be located at a frequency that is outside frequency range 225. OBB 220 may be a continuous wave signal where its energy may be confined to a single frequency. Signal 205, NBB 210, and IBB 215 may be modulated signals with respective bandwidths where energy is spread across a range of frequencies.

Signal 205, NBB 210, IBB 215, and OBB 220 may all be received by the local network entity receiver at different transmission powers. For example, 3GPP specifies the power level of NBB 210 may be −41 dBm, the power level of IBB 215 may be −35 dBm, the power level of OBB 220 may be −15 dBm, and the power level of signal 205 may be a REFSENSE+6 dB. However, these power levels are given as examples and may be any other various power levels.

As described herein, the NBB 210, the IBB 215, and the OBB 220 may impact or interfere with the signal 205, and the network entity 105 may implement the techniques described herein to account for the NBB 210, the IBB 215, and/or the OBB 220. More particularly, the network entity 105 may partition a range of gain stain values into different regions or ranges, where the different regions or ranges correspond to different prescale backoffs (e.g., maximum, variable, or minimum prescale backoff values), and the network entity 105 may then apply a prescale backoff based on the gain state value associated with the signal. The network entity 105 may process the prescaled signal (e.g., using FFT techniques, decoding techniques, or a combination thereof)

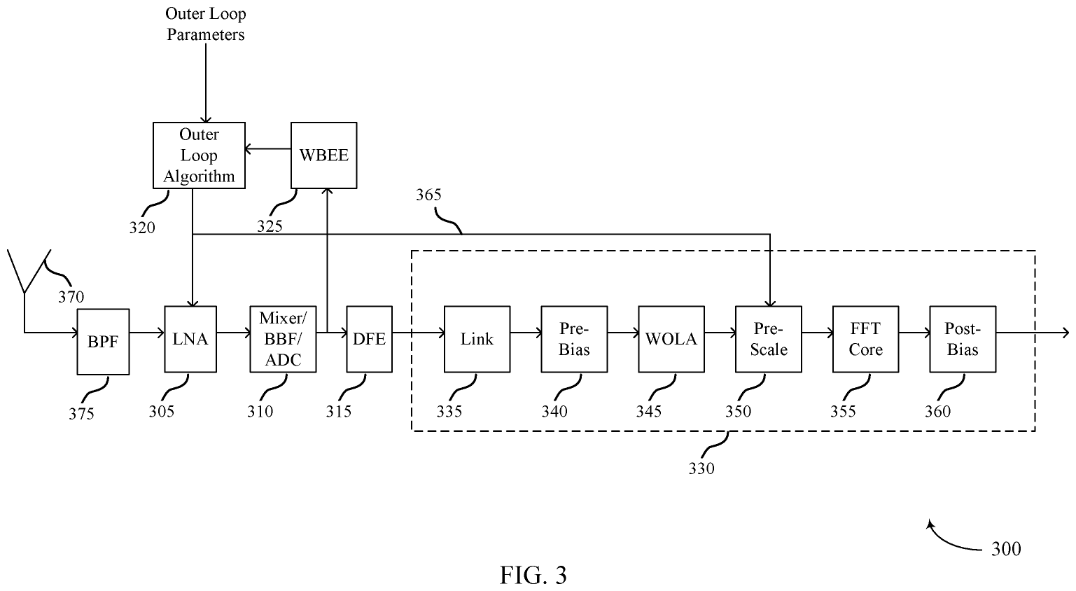

FIG. 3 shows an example of a radio frequency (RF) chain schematic 300 that supports out of band blocker handling for local area base station in accordance with one or more aspects of the present disclosure. RF chain schematic 300 may be found in a receiver of a local network entity 105.

RF chain schematic 300 may comprise various radio frequency components including antenna 370, bandpass filter (BPF) 375, low noise amplifier (LNA) 305, Mixer/band filter (BBF)/analog-to-digital converter (ADC) 310, digital front end (DFE) 315, outer loop algorithm 320, wideband energy estimator (WBEE) 325, and modem 330, where modem 330 may comprise link 335, pre-bias component 340, window overlap and add (WOLA) component 345, pre-scale component 350, Fast Fourier Transform (FFT) core 355, and post-bias component 360. One or more of the BPF 375, LNA 305, the mixer/band filter/ADC 310, the DFE 315, the WBEE 325, the outer loop algorithm 320, and the DFE 315 may be implemented in or supported by a radio-frequency integrated circuit (RFIC).

BPF 375 may receive an analog signal (e.g., from an antenna 370), and passes frequencies within a certain frequency range. LNA 305 may receive the filtered signal from BPF 375 and amplify the received signal. Mixer/BBF/ADC 310 may modulate, filter and convert the analog signal to a digital signal. DFE 315 may convert the digital signal from ADC 310 to a conditioned single combined baseband signal. The digital signal from ADC 310 may be passed by the WBEE 325 to outer loop algorithm 320. Outer loop algorithm 320 may be part of an automatic gain control (AGC) loop which receives outer loop parameters (e.g., AGC) and determines an AGC value (gain state value) for a particular slot or transmission time interval (TTI). The particular gain state value for the slot may then be transmitted to pre-scale component 345 in a control signal 365 (e.g., a control signal in serial communication protocol signaling).

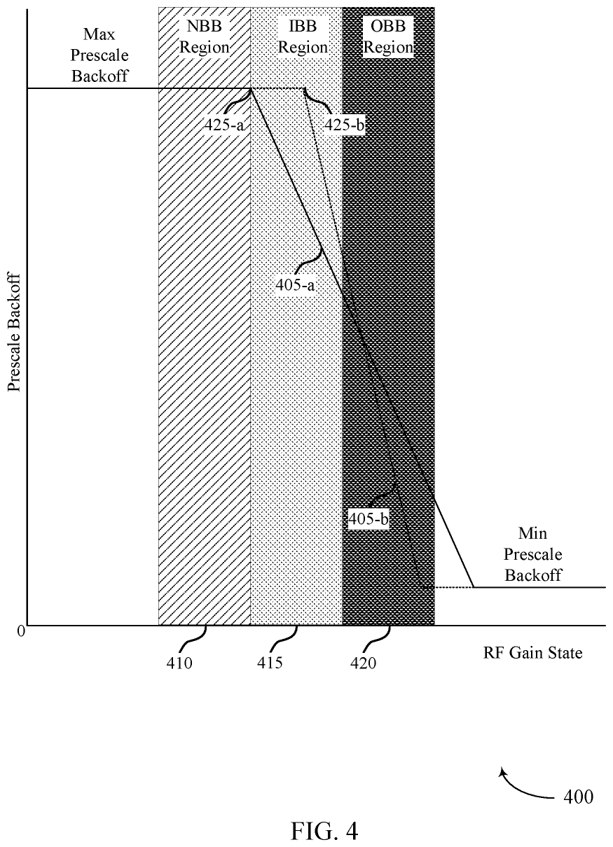

From DFE 315, the conditioned signal is received by modem 330 via link 335 and pre-bias component 340 further conditions the signal to establish proper operating conditions within modem 330. WOLA component 345 may implement a windowed overlap-add method to the signal. Pre-scale component 350 may then dynamically determine a prescale backoff value to be applied to the signal based on the received gain state value for the particular slot or TTI. The technique of dynamically determining the particular prescale backoff value is discussed further in the description related to FIG. 4 below.

FFT core 355 may then perform a fast Fourier transform on the pre-scaled signal from pre-scale component 350. The calculated prescale backoff value may not be too low to saturate the FFT, but also may not be too high for the signal to go below an FFT quantization noise level. FFT core 355 may then communicate the resulting signal to post-bias component 360 which will further prepare the signal for decoding and/or processing.

FIG. 4 shows an example of a gain chart 400 that supports out of band blocker handling for local area base station in accordance with one or more aspects of the present disclosure. Gain chart 400 illustrates a calculated prescale backoff value applied to a received signal corresponding to a particular RF gain state value that is conveyed, for example, from an outer loop algorithm 320 to a pre-scale component 345. A higher gain state value may correspond to a lower gain and vice-versa. At least a portion of the prescale backoff value may be calculated at pre-scale component 345.

Gain chart 400 may include various regions of operations that may correspond to prescale backoff values that may affect respective blockers. For example, gain chart 400 may include NBB region 410, IBB region 415, and OBB region 420. Gain chart 400 may begin at a 0 gain state value (corresponds to maximum gain) and increase in +1 increments as the gain decreases in 1 dB steps. A 0 gain state value may correspond to a maximum prescale backoff value which may be predetermined or may correspond to a power level of a particular blocker. In some examples, the prescale backoff value is based on a maximum gain value for a modem associated with the network entity. As the gain state value is increased, the particular gain state values may correspond to multiple regions of operation associated with respective blockers. For example, as illustrated in gain chart 400, as the gain state value is increased from 0, the first region of operation that is encountered is NBB region 410. For gain state values corresponding to NBB region 410, the resulting prescale backoff value may continue to be the maximum prescale backoff value. In some examples, the maximum prescale backoff value may correspond to a first range of gain state values associated with gain chart 400.

As the gain state value is increased further, the next region of operation that is encountered is IBB region 415. At inflection point 425-a, at the border between NBB region 410 and IBB region 415, slope 405-a corresponding to the prescale backoff value may be calculated based on numerous factors. For example, the slope of the prescale backoff value may be determined based on a power value associated with the narrowband blocker, the particular gain state value, and the maximum prescale backoff value. The slope may be calculated as the particular gain state value is increased from IBB region 415 through at least a portion of OBB region 420. In some examples, this variable prescale backoff value may correspond to a second range of gain state values associated with gain chart 400, the second range of gain state values following the first range of gain state values described above. In some examples, inflection point 425-a may be determined based on the power value associated with the narrowband blocker, a maximum gain for a receiver associated with the received signal, the maximum prescale backoff value, and a maximum signal for FFT core 355 without saturation. For example, the maximum signal for FFT core 355 may be a maximum gain value that is able to be input into FFT core 355 without saturating the resulting signal.

In some examples, the slope of the prescale backoff value may be predetermined. In some examples, both inflection point 425 and slope 405 may be adjusted based on changing power values of one or more blockers. For example, if the power value of the narrowband blocker is higher than the power value of the narrowband blocker in the scenario corresponding to inflection point 425-a and slope 405-a, inflection point 425 and slope 405 may be adjusted such that the inflection point occurs at inflection point 425-b and the resulting slope 405-b is steeper than slope 405-a.

As the gain state value is increased further past OBB region 420, the particular gain state value may not fall within either NBB region 410, IBB region 415, and OBB region 420. This region of gain chart 400 may correspond to a minimum prescale backoff value which may be predetermined or may correspond to a power level of a particular blocker. In some examples, the minimum prescale backoff value may correspond to a third range of gain state values associated with gain chart 400, the third range of gain state values following the first and second range of gain state values described above.

In some examples, the first range of gain state values, which corresponds to a maximum prescale backoff value (e.g., 15 dB), may include the gain state values of 0 to 15). In these examples, the first range may also include the NBB region 410 that includes the gain state values of 10 to 15. Additionally, in these examples, the second range of gain state values, which corresponds to the variable prescale backoff values includes the gain state values of 15 to 27. The second range may also include the IBB region 415 (including gain state values of 15 to 20) and the OBB region 420 (including gain state values of 20 to 25). Additionally, in these examples, the third range of gain state values, which corresponds to the minimum prescale backoff value (e.g., 3 DB), may include the gain state values of 27 to about 50.

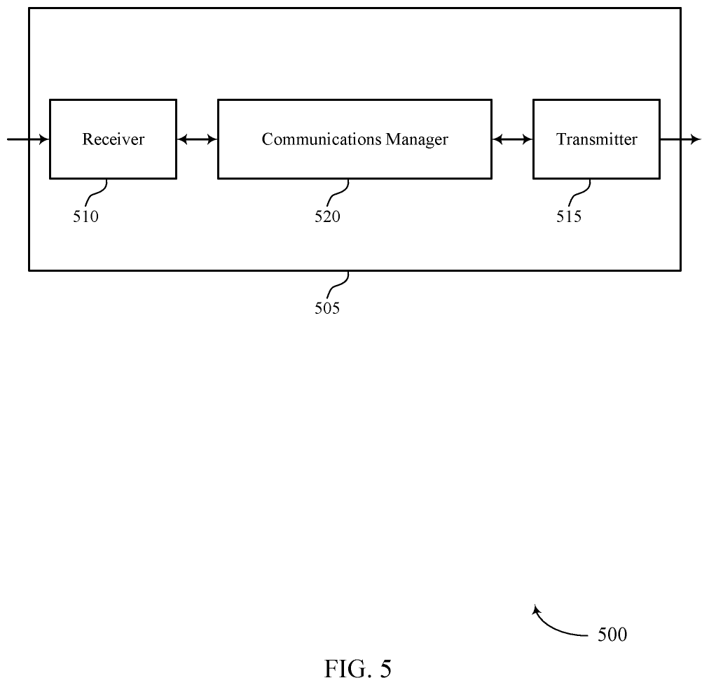

FIG. 5 shows a block diagram 500 of a device 505 that supports out of band blocker handling for local area base station in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of out of band blocker handling for local area base station as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for partitioning a range of gain state values into a set of multiple regions of operation, each of the set of multiple regions of operation being associated with a respective blocker of a set of multiple blockers. The communications manager 520 is capable of, configured to, or operable to support a means for calculating, for a received signal, a prescale backoff value for one or more gain state values within the range of gain state values based on a particular gain state value being within a corresponding region of operation of the set of multiple regions of operation. The communications manager 520 is capable of, configured to, or operable to support a means for applying the calculated prescale backoff value to the received signal, the application of the calculated prescale backoff value resulting in a prescaled signal. The communications manager 520 is capable of, configured to, or operable to support a means for processing the prescaled signal.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for calculating a prescale backoff value to be applied to a received signal. Advantages to determining a variable backoff value based on a range of gain state values allows a local network entity to achieve SNR and SQNR requirements while achieving high throughput.

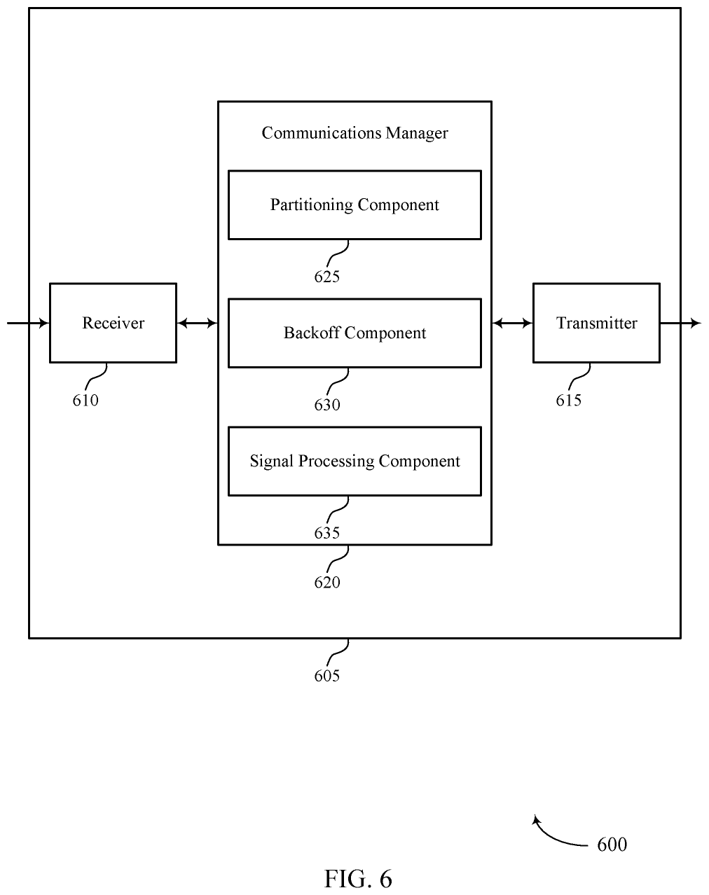

FIG. 6 shows a block diagram 600 of a device 605 that supports out of band blocker handling for local area base station in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of out of band blocker handling for local area base station as described herein. For example, the communications manager 620 may include a partitioning component 625, a backoff component 630, a signal processing component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The partitioning component 625 is capable of, configured to, or operable to support a means for partitioning a range of gain state values into a set of multiple regions of operation, each of the set of multiple regions of operation being associated with a respective blocker of a set of multiple blockers. The backoff component 630 is capable of, configured to, or operable to support a means for calculating, for a received signal, a prescale backoff value for one or more gain state values within the range of gain state values based on a particular gain state value being within a corresponding region of operation of the set of multiple regions of operation. The backoff component 630 is capable of, configured to, or operable to support a means for applying the calculated prescale backoff value to the received signal, the application of the calculated prescale backoff value resulting in a prescaled signal. The signal processing component 635 is capable of, configured to, or operable to support a means for processing the prescaled signal.

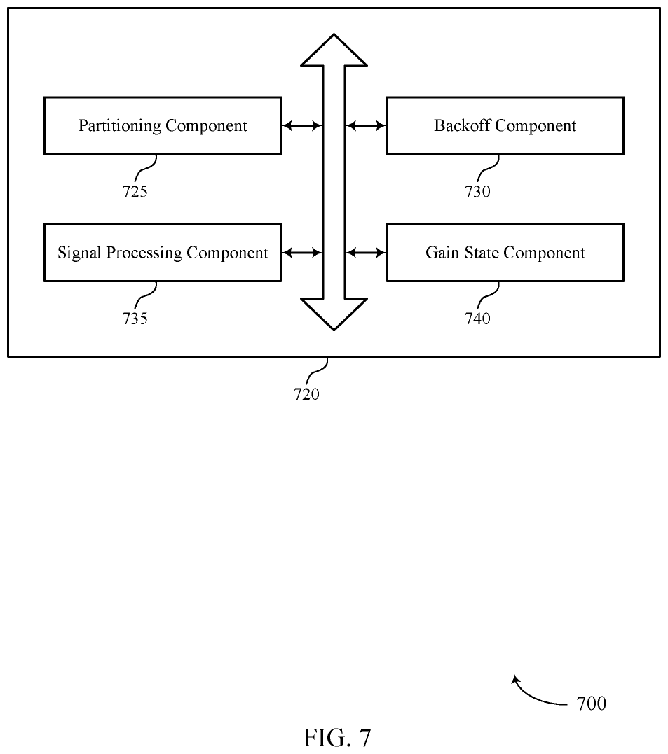

FIG. 7 shows a block diagram 700 of a communications manager 720 that supports out of band blocker handling for local area base station in accordance with one or more aspects of the present disclosure. The communications manager 720 may be an example of aspects of a communications manager 520, a communications manager 620, or both, as described herein. The communications manager 720, or various components thereof, may be an example of means for performing various aspects of out of band blocker handling for local area base station as described herein. For example, the communications manager 720 may include a partitioning component 725, a backoff component 730, a signal processing component 735, a gain state component 740, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The partitioning component 725 is capable of, configured to, or operable to support a means for partitioning a range of gain state values into a set of multiple regions of operation, each of the set of multiple regions of operation being associated with a respective blocker of a set of multiple blockers. The backoff component 730 is capable of, configured to, or operable to support a means for calculating, for a received signal, a prescale backoff value for one or more gain state values within the range of gain state values based on a particular gain state value being within a corresponding region of operation of the set of multiple regions of operation. In some examples, the backoff component 730 is capable of, configured to, or operable to support a means for applying the calculated prescale backoff value to the received signal, the application of the calculated prescale backoff value resulting in a prescaled signal. The signal processing component 735 is capable of, configured to, or operable to support a means for processing the prescaled signal.

In some examples, to support calculating the prescale backoff value, the gain state component 740 is capable of, configured to, or operable to support a means for determining that the particular gain state value is either less than gain state values associated with a region of operation associated with a narrowband blocker, an in-band blocker, or an out-of-band blocker, or is within a region of operation associated with the narrowband blocker. In some examples, to support calculating the prescale backoff value, the backoff component 730 is capable of, configured to, or operable to support a means for calculating, based on the determining, the prescale backoff value corresponding to the particular gain state value to be a maximum prescale backoff value.

In some examples, to support calculating the prescale backoff value, the gain state component 740 is capable of, configured to, or operable to support a means for determining that the particular gain state value is within a region of operation associated with an in-band blocker or an out-of-band blocker. In some examples, to support calculating the prescale backoff value, the backoff component 730 is capable of, configured to, or operable to support a means for calculating, based on the determining, the prescale backoff value corresponding to the particular gain state value based on a power value associated with a blocker of the set of multiple blockers, the particular gain state value, and a maximum prescale backoff value.

In some examples, the calculated prescale backoff value corresponding to the particular gain state value located at a border between a region of operation associated with a narrowband blocker and the region of operation associated with the in-band blocker is a maximum prescale backoff value.

In some examples, the border between the region of operation associated with the narrowband blocker and the region of operation associated with the in-band blocker is determined based on the power value associated with the blocker of the set of multiple blockers, a maximum gain for a receiver associated with the received signal, the maximum prescale backoff value, and a maximum signal for a fast Fourier transform core.

In some examples, the blocker is a narrowband blocker.

In some examples, the prescale backoff value is based on a maximum gain value for a modem associated with the network entity.

In some examples, to support calculating the prescale backoff value, the gain state component 740 is capable of, configured to, or operable to support a means for determining that the particular gain state value is greater than gain state values associated with regions of operation associated with a narrowband blocker, an in-band blocker, or an out-of-band blocker. In some examples, to support calculating the prescale backoff value, the backoff component 730 is capable of, configured to, or operable to support a means for calculating, based on the determining, the prescale backoff value corresponding to the particular gain state value to be a minimum prescale backoff value.

In some examples, the network entity is a local network entity.

In some examples, to support partitioning the range of gain state values, the gain state component 740 is capable of, configured to, or operable to support a means for associating a maximum prescale backoff value to a first subrange of the range of gain state values. In some examples, to support partitioning the range of gain state values, the gain state component 740 is capable of, configured to, or operable to support a means for associating a variable prescale backoff value to a second subrange of the range of gain state values. In some examples, to support partitioning the range of gain state values, the gain state component 740 is capable of, configured to, or operable to support a means for associating a minimum prescale backoff value to a third subrange of the range of gain state values, where the calculated prescale backoff value is dependent on whether the particular gain state value is within the first subrange, the second subrange, or the third subrange.

In some examples, to support associating the variable prescale backoff value to the second subrange of the range of gain state values, the backoff component 730 is capable of, configured to, or operable to support a means for calculating a slope value corresponding to the variable prescale backoff value, where the slope value is applied to the prescale backoff value between the first subrange of the range of gain state values and the third subrange of the range of gain state values.

In some examples, the gain state component 740 is capable of, configured to, or operable to support a means for receiving, from an automatic gain control loop including one or more radio frequency components of the network entity, a control signal indicating the particular gain state value.

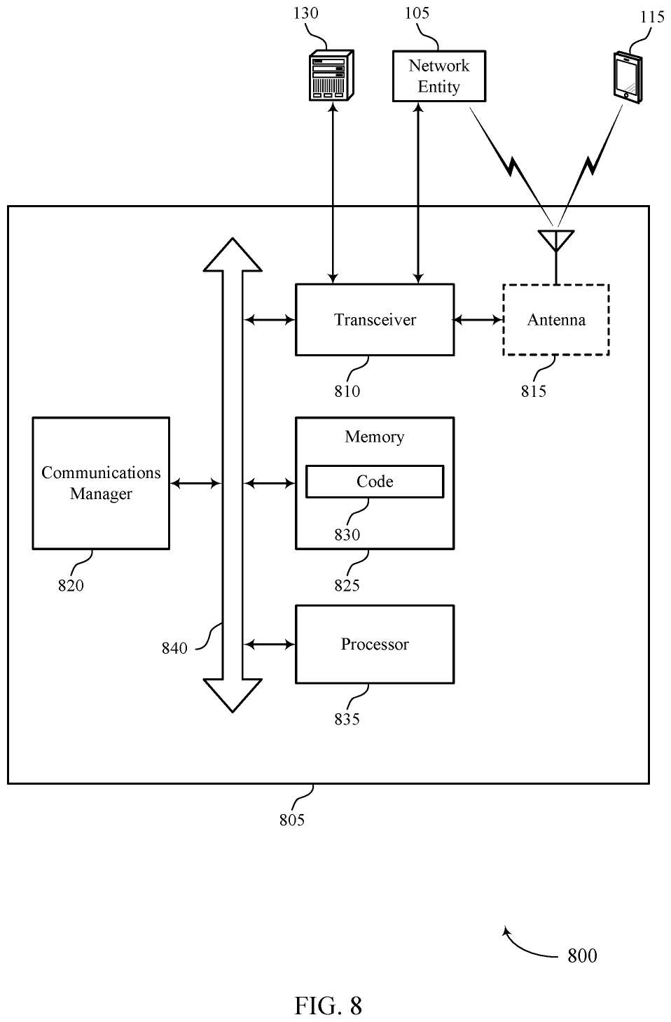

FIG. 8 shows a diagram of a system 800 including a device 805 that supports out of band blocker handling for local area base station in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting out of band blocker handling for local area base station). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. As such, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for partitioning a range of gain state values into a set of multiple regions of operation, each of the set of multiple regions of operation being associated with a respective blocker of a set of multiple blockers. The communications manager 820 is capable of, configured to, or operable to support a means for calculating, for a received signal, a prescale backoff value for one or more gain state values within the range of gain state values based on a particular gain state value being within a corresponding region of operation of the set of multiple regions of operation. The communications manager 820 is capable of, configured to, or operable to support a means for applying the calculated prescale backoff value to the received signal, the application of the calculated prescale backoff value resulting in a prescaled signal. The communications manager 820 is capable of, configured to, or operable to support a means for processing the prescaled signal.

By including or configuring the communications manager 820 in accordance with examples as described herein, the device 805 may support techniques for calculating a prescale backoff value to be applied to a received signal. Advantages to determining a variable backoff value based on a range of gain state values allows a local network entity to achieve SNR and SQNR requirements while achieving high throughput.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of out of band blocker handling for local area base station as described herein, or the at least one processor 835 and the at least one memory 825 may be otherwise configured to, individually or collectively, perform or support such operations.

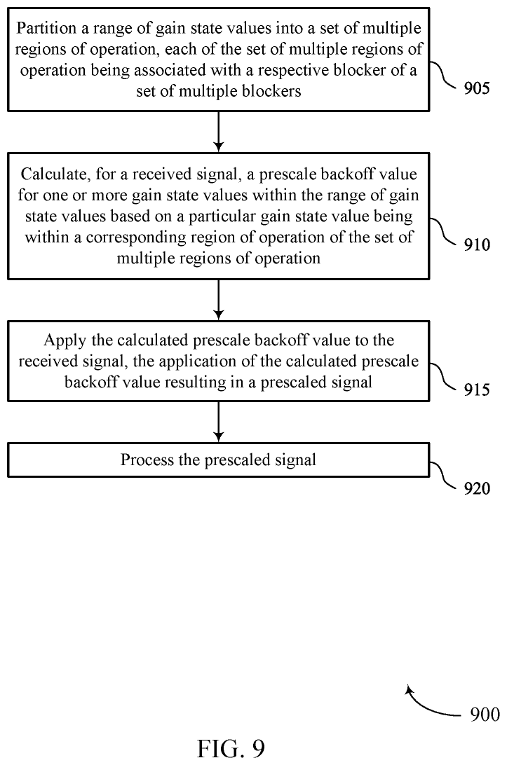

FIG. 9 illustrates a flowchart illustrating a method 900 that supports out of band blocker handling for local area base station in accordance with aspects of the present disclosure. The operations of method 900 may be implemented by a network entity 105 or its components as described herein. For example, the operations of method 900 may be performed by a communications manager as described with reference to FIGS. 5 through 8. In some examples, a network entity may execute a set of instructions to control the functional elements of the network entity to perform the functions described herein. Additionally, or alternatively, a network entity may perform aspects of the functions described herein using special-purpose hardware.

At 905, the method may include partitioning a range of gain state values into a set of multiple regions of operation, each of the set of multiple regions of operation being associated with a respective blocker of a set of multiple blockers. The operations of 905 may be performed in accordance with examples as disclosed herein. In some examples, aspects of the operations of 905 may be performed by a partitioning component 625 as described with reference to FIG. 6.

At 910, the method may include calculating, for a received signal, a prescale backoff value for one or more gain state values within the range of gain state values based on a particular gain state value being within a corresponding region of operation of the set of multiple regions of operation. The operations of 910 may be performed in accordance with examples as disclosed herein. In some examples, aspects of the operations of 910 may be performed by a backoff component 630 as described with reference to FIG. 6.

At 915, the method may include applying the calculated prescale backoff value to the received signal, the application of the calculated prescale backoff value resulting in a prescaled signal. The operations of 915 may be performed in accordance with examples as disclosed herein. In some examples, aspects of the operations of 915 may be performed by a backoff component 630 as described with reference to FIG. 6.

At 920, method may include processing the prescaled signal. The operations of 920 may be performed in accordance with examples as disclosed herein. In some examples, aspects of the operations of 920 may be performed by a signal processing component 635 as described with reference to FIG. 6.

The following provides an overview of aspects of the present disclosure:
Aspect 1: A method by a network entity, comprising: one or more memories storing processor-executable code; and one or more processors coupling with the one or more memories and individually or collectively operable to execute the code to cause the network entity to: partition a range of gain state values into a plurality of regions of operation, each of the plurality of regions of operation being associated with a respective blocker of a plurality of blockers; calculating, for a received signal, a prescale backoff value for one or more gain state values within the range of gain state values based at least in part on a particular gain state value being within a corresponding region of operation of the plurality of regions of operation; applying the calculated prescale backoff value to the received signal, the application of the calculated prescale backoff value resulting in a prescaled signal; and processing the prescaled signal.
Aspect 2: The method of aspect 1, wherein to calculating the prescale backoff value further comprises: determining that the particular gain state value is either less than gain state values associated with a region of operation associated with a narrowband blocker, an in-band blocker, or an out-of-band blocker, or is within a region of operation associated with the narrowband blocker; and calculate, basing at least in part on the determining, the prescale backoff value corresponding to the particular gain state value to be a maximum prescale backoff value.
Aspect 3: The method of any of aspects 1 through 2, wherein to calculating the prescale backoff value further comprises: determining that the particular gain state value is within a region of operation associated with an in-band blocker or an out-of-band blocker; and calculate, basing at least in part on the determining, the prescale backoff value corresponding to the particular gain state value based at least in part on a power value associated with a blocker of the plurality of blockers, the particular gain state value, and a maximum prescale backoff value.
Aspect 4: The method of aspect 3, wherein the calculated prescale backoff value corresponding to the particular gain state value located at a border between a region of operation associated with a narrowband blocker and the region of operation associated with the in-band blocker is a maximum prescale backoff value.
Aspect 5: The method of aspect 4, wherein the border between the region of operation associated with the narrowband blocker and the region of operation associated with the in-band blocker is determined based at least in part on the power value associated with the blocker of the plurality of blockers, a maximum gain for a receiver associated with the received signal, the maximum prescale backoff value, and a maximum signal for a fast Fourier transform core.
Aspect 6: The method of any of aspects 3 through 5, wherein the blocker is a narrowband blocker.
Aspect 7: The method of any of aspects 3 through 6, wherein the prescale backoff value is based at least in part on a maximum gain value for a modem associated with the network entity.
Aspect 8: The method of any of aspects 1 through 7, wherein to calculating the prescale backoff value further comprises: determining that the particular gain state value is greater than gain state values associated with regions of operation associated with a narrowband blocker, an in-band blocker, or an out-of-band blocker; and calculate, basing at least in part on the determining, the prescale backoff value corresponding to the particular gain state value to be a minimum prescale backoff value.
Aspect 9: The method of any of aspects 1 through 8, wherein the network entity is a local network entity.
Aspect 10: The method of any of aspects 1 through 9, wherein partitioning the range of gain state values comprises: associating a maximum prescale backoff value to a first subrange of the range of gain state values; associating a variable prescale backoff value to a second subrange of the range of gain state values; and associating a minimum prescale backoff value to a third subrange of the range of gain state values, wherein the calculated prescale backoff value is dependent on whether the particular gain state value is within the first subrange, the second subrange, or the third subrange.
Aspect 11: The method of aspect 10, wherein to associating the variable prescale backoff value to the second subrange of the range of gain state values further comprises: calculating a slope value corresponding to the variable prescale backoff value, wherein the slope value is applied to the prescale backoff value between the first subrange of the range of gain state values and the third subrange of the range of gain state values.
Aspect 12: The method of any of aspects 1 through 11, further comprising: receiving, from an automatic gain control loop comprising one or more radio frequency components of the network entity, a control signal indicating the particular gain state value.
Aspect 13: A network entity comprising one or more memories storing processor-executable code, and one or more processors coupled with the one or more memories and individually or collectively operable to execute the code to cause the network entity to perform a method of any of aspects 1 through 12.
Aspect 14: A network entity comprising at least one means for performing a method of any of aspects 1 through 12.
Aspect 15: A non-transitory computer-readable medium storing code the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
partition a range of gain state values into a plurality of regions of operation, each of the plurality of regions of operation being associated with a respective blocker of a plurality of blockers;
calculate, for a received signal, a prescale backoff value for one or more gain state values within the range of gain state values based at least in part on a particular gain state value being within a corresponding region of operation of the plurality of regions of operation;
apply the calculated prescale backoff value to the received signal, the application of the calculated prescale backoff value resulting in a prescaled signal; and
process the prescaled signal.

2. The network entity of claim 1, wherein, to calculate the prescale backoff value, the one or more processors are individually or collectively further operable to execute the code to cause the network entity to:
determine that the particular gain state value is either less than gain state values associated with a region of operation associated with a narrowband blocker, an in-band blocker, or an out-of-band blocker, or is within a region of operation associated with the narrowband blocker; and
calculate, based at least in part on the determining, the prescale backoff value corresponding to the particular gain state value to be a maximum prescale backoff value.

3. The network entity of claim 1, wherein, to calculate the prescale backoff value, the one or more processors are individually or collectively further operable to execute the code to cause the network entity to:
determine that the particular gain state value is within a region of operation associated with an in-band blocker or an out-of-band blocker; and
calculate, based at least in part on the determining, the prescale backoff value corresponding to the particular gain state value based at least in part on a power value associated with a blocker of the plurality of blockers, the particular gain state value, and a maximum prescale backoff value.

4. The network entity of claim 3, wherein the calculated prescale backoff value corresponding to the particular gain state value located at a border between a region of operation associated with a narrowband blocker and the region of operation associated with the in-band blocker is a maximum prescale backoff value.

5. The network entity of claim 4, wherein the border between the region of operation associated with the narrowband blocker and the region of operation associated with the in-band blocker is determined based at least in part on the power value associated with the blocker of the plurality of blockers, a maximum gain for a receiver associated with the received signal, the maximum prescale backoff value, and a maximum signal for a fast Fourier transform core.

6. The network entity of claim 3, wherein the blocker is a narrowband blocker.

7. The network entity of claim 3, wherein the prescale backoff value is based at least in part on a maximum gain value for a modem associated with the network entity.

8. The network entity of claim 1, wherein, to calculate the prescale backoff value, the one or more processors are individually or collectively further operable to execute the code to cause the network entity to:
determine that the particular gain state value is greater than gain state values associated with regions of operation associated with a narrowband blocker, an in-band blocker, or an out-of-band blocker; and
calculate, based at least in part on the determining, the prescale backoff value corresponding to the particular gain state value to be a minimum prescale backoff value.

9. The network entity of claim 1, wherein the network entity is a local network entity.

10. The network entity of claim 1, wherein, to partition the range of gain state values, the one or more processors are individually or collectively operable to execute the code to cause the network entity to:
associate a maximum prescale backoff value to a first subrange of the range of gain state values;
associate a variable prescale backoff value to a second subrange of the range of gain state values; and
associate a minimum prescale backoff value to a third subrange of the range of gain state values, wherein the calculated prescale backoff value is dependent on whether the particular gain state value is within the first subrange, the second subrange, or the third subrange.

11. The network entity of claim 10, wherein, to associate the variable prescale backoff value to the second subrange of the range of gain state values, the one or more processors are individually or collectively further operable to execute the code to cause the network entity to:
calculate a slope value corresponding to the variable prescale backoff value, wherein the slope value is applied to the prescale backoff value between the first subrange of the range of gain state values and the third subrange of the range of gain state values.

12. The network entity of claim 1, wherein the one or more processors are individually or collectively further operable to execute the code to cause the network entity to:
receive, from an automatic gain control loop comprising one or more radio frequency components of the network entity, a control signal indicating the particular gain state value.

13. A method for wireless communications at a network entity, comprising:
partitioning a range of gain state values into a plurality of regions of operation, each of the plurality of regions of operation being associated with a respective blocker of a plurality of blockers;
calculating, for a received signal, a prescale backoff value for one or more gain state values within the range of gain state values based at least in part on a particular gain state value being within a corresponding region of operation of the plurality of regions of operation;
applying the calculated prescale backoff value to the received signal, the application of the calculated prescale backoff value resulting in a prescaled signal; and
processing the prescaled signal.

14. The method of claim 13, wherein calculating the prescale backoff value further comprises:
determining that the particular gain state value is either less than gain state values associated with a region of operation associated with a narrowband blocker, an in-band blocker, or an out-of-band blocker, or is within a region of operation associated with the narrowband blocker; and
calculating, based at least in part on the determining, the prescale backoff value corresponding to the particular gain state value to be a maximum prescale backoff value.

15. The method of claim 13, wherein calculating the prescale backoff value further comprises:
determining that the particular gain state value is within a region of operation associated with an in-band blocker or an out-of-band blocker; and
calculating, based at least in part on the determining, the prescale backoff value corresponding to the particular gain state value based at least in part on a power value associated with a blocker of the plurality of blockers, the particular gain state value, and a maximum prescale backoff value.

16. The method of claim 15, wherein the calculated prescale backoff value corresponding to the particular gain state value located at a border between a region of operation associated with a narrowband blocker and the region of operation associated with the in-band blocker is a maximum prescale backoff value.

17. The method of claim 16, wherein the border between the region of operation associated with the narrowband blocker and the region of operation associated with the in-band blocker is determined based at least in part on the power value associated with the blocker of the plurality of blockers, a maximum gain for a receiver associated with the received signal, the maximum prescale backoff value, and a maximum signal for a fast Fourier transform core.

18. The method of claim 15, wherein the blocker is a narrowband blocker.

19. The method of claim 15, wherein the prescale backoff value is based at least in part on a maximum gain value for a modem associated with the network entity.

20. The method of claim 13, wherein calculating the prescale backoff value further comprises:
determining that the particular gain state value is greater than gain state values associated with regions of operation associated with a narrowband blocker, an in-band blocker, or an out-of-band blocker; and
calculating, based at least in part on the determining, the prescale backoff value corresponding to the particular gain state value to be a minimum prescale backoff value.

21. The method of claim 13, wherein the network entity is a local network entity.

22. The method of claim 13, wherein partitioning the range of gain state values comprises:
associating a maximum prescale backoff value to a first subrange of the range of gain state values;
associating a variable prescale backoff value to a second subrange of the range of gain state values; and
associating a minimum prescale backoff value to a third subrange of the range of gain state values, wherein the calculated prescale backoff value is dependent on whether the particular gain state value is within the first subrange, the second subrange, or the third subrange.

23. The method of claim 22, wherein associating the variable prescale backoff value to the second subrange of the range of gain state values further comprises:
calculating a slope value corresponding to the variable prescale backoff value, wherein the slope value is applied to the prescale backoff value between the first subrange of the range of gain state values and the third subrange of the range of gain state values.

24. The method of claim 13, further comprising:
receiving, from an automatic gain control loop comprising one or more radio frequency components of the network entity, a control signal indicating the particular gain state value.

25. A network entity for wireless communications, comprising:
means for partitioning a range of gain state values into a plurality of regions of operation, each of the plurality of regions of operation being associated with a respective blocker of a plurality of blockers;
means for calculating, for a received signal, a prescale backoff value for one or more gain state values within the range of gain state values based at least in part on a particular gain state value being within a corresponding region of operation of the plurality of regions of operation;
means for applying the calculated prescale backoff value to the received signal, the application of the calculated prescale backoff value resulting in a prescaled signal; and
means for processing the prescaled signal.

26. The network entity of claim 25, wherein the means for calculating the prescale backoff value further comprise:
means for determining that the particular gain state value is either less than gain state values associated with a region of operation associated with a narrowband blocker, an in-band blocker, or an out-of-band blocker, or is within a region of operation associated with the narrowband blocker; and
means for calculating, based at least in part on the determining, the prescale backoff value corresponding to the particular gain state value to be a maximum prescale backoff value.

27. The network entity of claim 25, wherein the means for calculating the prescale backoff value further comprise:
means for determining that the particular gain state value is within a region of operation associated with an in-band blocker or an out-of-band blocker; and
means for calculating, based at least in part on the determining, the prescale backoff value corresponding to the particular gain state value based at least in part on a power value associated with a blocker of the plurality of blockers, the particular gain state value, and a maximum prescale backoff value.

28. The network entity of claim 27, wherein the calculated prescale backoff value corresponding to the particular gain state value located at a border between a region of operation associated with a narrowband blocker and the region of operation associated with the in-band blocker is a maximum prescale backoff value.

29. The network entity of claim 28, wherein the border between the region of operation associated with the narrowband blocker and the region of operation associated with the in-band blocker is determined based at least in part on the power value associated with the blocker of the plurality of blockers, a maximum gain for a receiver associated with the received signal, the maximum prescale backoff value, and a maximum signal for a fast Fourier transform core.

30. A non-transitory computer-readable medium storing code for wireless communications, the code comprising instructions executable by one or more processors to:
partition a range of gain state values into a plurality of regions of operation, each of the plurality of regions of operation being associated with a respective blocker of a plurality of blockers;
calculate, for a received signal, a prescale backoff value for one or more gain state values within the range of gain state values based at least in part on a particular gain state value being within a corresponding region of operation of the plurality of regions of operation;
apply the calculated prescale backoff value to the received signal, the application of the calculated prescale backoff value resulting in a prescaled signal; and
process the prescaled signal.
